(19) United States
(12) Patent Application Publication
(10) Pub. No.: US 2024/0049162 A1
(43) Pub. Date: Feb. 8, 2024

(54) RADIO NETWORK NODE, USER EQUIPMENT AND METHODS PERFORMED IN A WIRELESS COMMUNICATION NETWORK

(71) Applicant: Telefonaktiebolaget LM Ericsson (publ), Stockholm (SE)

(72) Inventors: Tamas Borsos, BUDAPEST (HU); András Rácz, BUDAPEST (HU); András Veres, BUDAPEST (HU); Lackis Eleftheriadis, VALBO (SE); Adam Bergkvist, LULEÅ (SE)

(21) Appl. No.: 18/266,633

(22) PCT Filed: Dec. 23, 2020
(86) PCT No.: PCT/SE2020/051262

§ 371 Date: Jun. 12, 2023

(51) Int. Cl. H04W 64/00; G01S 5/00; H04W 24/08

(52) U.S. Cl. CPC H04W 64/00; G01S 5/012; H04W 24/08

(57) ABSTRACT

Embodiments herein relate to, for example, a method performed by a UE for handling positioning of the UE in a wireless communication network. The UE measures a CIR of a signal from a radio network node; and initiates a process for determining whether the UE is indoors or outdoors using an ML model with the measured CIR as input.

### TECHNICAL FIELD

Embodiments herein relate to a radio network node, a User Equipment (UE) and methods performed therein regarding wireless communication. Furthermore, a computer program product and a computer-readable storage medium are also provided herein. Especially, embodiments herein relate to handling positioning of the UE such as enabling determination of environment presence of the UE, for example, determining whether the UE is indoors or outdoors, in a wireless communication network.

### BACKGROUND

In a typical wireless communication network, UEs, also known as wireless communication devices, mobile stations, stations (STA) and/or wireless devices, communicate via a Radio Access Network (RAN) to one or more Core Networks (CN). The RAN covers a geographical area which is divided into service areas or cell areas, with each service area or cell area being served by network node such as an access node e.g. a W-Fi access point or a Radio Base Station (RBS), which in some Radio Access Technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a Downlink (DL) to the wireless device and the wireless device communicates over an Uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using Wideband Code Division Multiple Access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases (Rel). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies also known as new radio (NR), the use of e.g. very many transmit- and receive-antenna elements makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

The radio network design and optimization process may require a set of input data, including network requirements, existing parameters and radio measurements. In certain cases, e.g. in optimization process or radio coverage extension such as for densification, adding new carriers and new frequencies, network services are already available in the area, which allows collecting live radio measurement from the investigated area. Typical parameters to collect are received signal strength, e.g. Reference Signal Received Power (RSRP), and received signal quality e.g. Reference Signal Received Quality (RSRQ). The source of the measurements can be from active measurements, reporting from “friendly” users or even crowd-sourced data which is a cost-efficient way of scaling up the measurements and gives good diversity. In either of these cases the measurements should be recorded together with a geographical position for coverage and/or quality planning.

One reason for collecting the position data of UEs is to determine whether the report came from an indoor or an outdoor area, because these areas are often covered by separate dedicated cells. However, the position is often not accurate enough to provide this information, especially around the borderlines of the cells. The knowledge of being indoor or outdoor can prevent mistakes of concluding, e.g., that the indoor coverage gives low quality if we know that the measurements about the indoor cell actually came from outdoor, which is obviously not the intended coverage area, or vice versa.

Existing solutions for indoor/outdoor differentiation and related prior art is exemplified in e.g. “Sound based indoor and outdoor environment detection for seamless positioning handover” Rakmin Sung, Suk-hoon Jung, Dongsoo Han, Elsevier, ScienceDirect ICT Express 1 (2015) 106-109, and WO2017061920A1 which are described in more detail below. In “Sound based indoor and outdoor environment detection for seamless positioning handover” Rakmin Sung, Suk-hoon Jung, Dongsoo Han, Elsevier, ScienceDirect ICT Express 1 (2015) 106-109, the authors develop a method for switching between indoor and outdoor positioning systems based on the observed background noises and reflections of special test noise signals. Although the solution is developed for positioning systems, they try to tackle the same problem, e.g., how to choose between location systems when both are available, e.g., Global Positioning System, GPS, and indoor, such that whenever the UE is indoors it is connected to the indoor system and when the UE is outdoor it is connected to the outdoor system. To solve this problem, they try to rely on the noise patterns that is observed indoor and outdoor, which they claim to be characteristically different.

In WO2017061920A1, the authors propose that a UE may explicitly report to the radio network, whether the UE is located indoors or outdoors and the radio network may adjust handover parameters and transmission powers to achieve the desired distribution and assignment of UEs to indoor and outdoor cells. To determine whether the UE is indoors or outdoors, the authors list possible mechanisms, such as using sensors in the phone, e.g. temperature, light sensors, magnetic sensors or availability of indoor positioning systems, etc.

Current existing solutions such as “Sound based indoor and outdoor environment detection for seamless positioning handover” Rakmin Sung, Suk-hoon Jung, Dongsoo Han, Elsevier, ScienceDirect ICT Express 1 (2015) 106-109 use external probes to capture the differences between indoor/outdoor coverage.

### SUMMARY

An object of embodiments herein is to provide a mechanism that efficiently enables determination of environment presence of a UE in the wireless communication network.

According to an aspect, the object is achieved by providing a method performed by a UE for handling positioning of the UE in a wireless communication network. The UE measures a Channel Impulse Response (CIR) of a signal from a radio network node. The UE further initiates a process for determining whether the UE is indoors or outdoors using a Machine Learning (ML) model with the measured CIR as input.

According to another aspect the object is achieved by providing a method performed by a radio network node for handling positioning of a UE in a wireless communication network. The radio network node obtains a measurement of a CIR of a signal in the wireless communication network. The radio network node further determines whether the UE is indoors or outdoors using a ML model with the measurement of the CIR as input.

According to still another aspect, the object is achieved by providing a UE and a radio network node configured to perform the methods herein. Thus, it is herein provided a UE for handling positioning of the UE in a wireless communication network. The UE is configured to measure a CIR of a signal from a radio network node. The UE is further configured to initiate a process for determining whether the UE is indoors or outdoors using a ML model with the measured CIR as input. Furthermore, it is herein provided a radio network for handling positioning of a UE in a wireless communication network. The radio network node obtains a measurement of a CIR of a signal in the wireless communication network. The radio network node further determines whether the UE is indoors or outdoors using a ML model with the measurement of the CIR as input.

It is furthermore provided herein a computer program product comprising instructions, which, when executed on at least one processor, cause the at least one processor to carry out any of the methods above, as performed by the radio network node, or the UE, respectively. It is additionally provided herein a computer-readable storage medium, having stored thereon a computer program product comprising instructions which, when executed on at least one processor, cause the at least one processor to carry out the method according to any of the methods above, as performed by the radio network node, or the UE, respectively.

It is herein disclosed a solution where the UE presence of being indoors or outdoors is determined by an ML model based on the patterns in the CIR. The CIR is different in indoor positions and outdoor positions due to the difference in the multi-path signal propagation properties. Only radio signal measurements are used to determine UE presence, which are available in the radio network, i.e., no environmental sensors or positioning systems are assumed.

New measurements may be introduced, e.g. either in UE side or at cell site, that measure the more detailed channel response characteristics, e.g. including the multi-path effects, that characterize the propagation environment.

The ML model may be trained to distinguish the propagation environments of indoors and outdoors and to classify a UE presence based on that. The ML model may be taught offline and may not necessarily be specific to given cell. The ML model may be provided as part of the algorithm, e.g. as a configuration set of the algorithm.

An advantage of the solution is that the UE presence can be determined to be indoor or outdoor, purely based on radio signal measurements without external sensor measurements and reporting, e.g., from a terminal application or no extra indoor/outdoor positioning system is not needed. Therefore, the solution is more feasible and easier to realize. Since no UE sensors are used, there are also no issues related to user privacy, resulting in an efficient manner for establishing UE environment presence, which leads to an improved performance of the wireless communication network since the cell planning may be more accurate.

### BRIEF DESCRIPTION OF THE DRAWINGS

Embodiments will now be described in more detail in relation to the enclosed drawings, in which:

FIG. 1 is a schematic overview depicting a wireless communication network according to embodiments herein;

FIG. 2a is a combined signalling scheme and flowchart according to embodiments herein;

FIG. 2b is a combined signalling scheme and flowchart according to embodiments herein;

FIG. 2c is a combined signalling scheme and flowchart according to embodiments herein;

FIG. 3 is a flowchart depicting methods according to embodiments herein;

FIG. 4 is a diagram depicting CIR for a UE being indoors;

FIG. 5 is a diagram depicting CIR for a UE being outdoors;

FIG. 6 is a flowchart depicting a method performed by a UE according to embodiments herein;

FIG. 7 is a flowchart depicting a method performed by a radio network node according to embodiments herein;

FIG. 8 is a block diagram depicting a UE according to embodiments herein;

FIG. 9 is a block diagram depicting a radio network node according to embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12-15 are flowcharts illustrating methods implemented in a communication system including a host computer, a base station and a user equipment.

### DETAILED DESCRIPTION

Embodiments herein are described within the context of 3GPP NR radio technology, e.g. as disclosed in 3GPP TS 38.300 V15.2.0 (2018 June). It is understood, that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

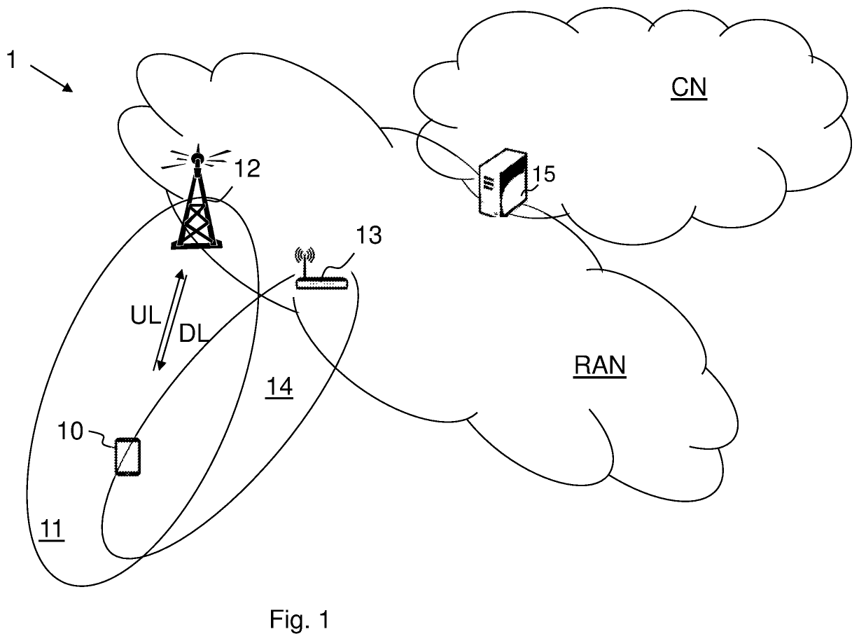

Embodiments herein relate to wireless communication networks in general. FIG. 1 is a schematic overview depicting a wireless communication network 1. The wireless communication network 1 comprises one or more RANs and one or more CNs. The wireless communication network 1 may use one or a number of different technologies, such as W-Fi, LTE, LTE-Advanced, Fifth Generation (5G), WCDMA, Global System for Mobile communications/Enhanced Data rate for GSM Evolution (GSM/EDGE), Worldwide Interoperability for Microwave Access (WiMAX), or Ultra Mobile Broadband (UM B), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices e.g. a UE 10 such as a mobile station, a non-access point (non-AP) STA, a STA, a user equipment and/or a wireless terminal, communicate via one or more Access Networks (AN), e.g. RANs, to one or more CNs. It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station capable of communicating using radio communication with a network node within an area served by the network node.

The wireless communication network 1 comprises a first radio network node 12 providing radio coverage over a geographical area, a first cell 11 or first service area, of a RAT, such as LTE, WiMAX or similar. The first radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the first network node 12 depending e.g. on the RAT and terminology used. The first radio network node 12 may alternatively or additionally be a controller node or a packet processing node such as a radio controller node or similar. The first radio network node 12 may be referred to as the radio network node 12 or as a primary serving network node wherein the first cell 11 may be referred to as a telecommunication cell or a primary cell, and the serving network node 12 communicates with the UE 10 in form of DL transmissions to the UE 10 and UL transmissions from the UE 10.

The wireless communication network 1 comprises a second radio network node 13 providing radio coverage over a geographical area, a second cell 14 or second service area, of a RAT, such as LTE, WiMAX or similar. The second radio network node 13 may be a transmission and reception point e.g. a radio network node such as a WLAN access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the second radio network node 13 depending e.g. on the radio access technology and terminology used. The second radio network node 13 may be referred to as the indoor radio network node wherein the second cell 14 may be referred to as an indoor cell, and the second radio network node 13 communicates with the UE 10 in form of DL transmissions to the UE 10 and UL transmissions from the UE 10.

It should be noted that a cell may be denoted as service area, beam, beam group or similar to define an area of radio coverage.

The wireless communication network 1 may further comprise a network node 15 comprising one or more applications for, for example, determining cell planning or similar.

Referring to a prior art document CN106664265B, wherein a fingerprint-based positioning system is described, which measures and analyses the CIR of a reference signal after traversing a multipath channel. ML is proposed to process this detailed dataset. However, the CIR is for positioning in a radio fingerprinting type algorithm: Channel impulse responses are recorded from a plurality of locations, where each stored channel impulse response is associated with a location and where ML is used to match the CIR patterns to find a location. Fingerprint-based positioning however requires a large database of CIR-locations, which must be created principally for each position one wants to localize later. It requires a thorough work, i.e. to walk around, in the target area. Further, fingerprint-based positioning systems are not generalizable to other areas, as one must do the same preparations at every location, and it cannot tell if the location is indoor or outdoor.

According to embodiments herein, it is herein provided a solution where the UE presence of indoor or outdoor is determined by an ML model based on the patterns in a CIR. The CIR is different in indoor and outdoor due to the difference in the multi-path signal propagation properties. Only radio signal measurements are used to determine the UE presence, which are available in the radio network, i.e., no environmental sensors or positioning systems are assumed. The measurements, e.g. either on the UE side or at a cell site, measure detailed CIR characteristics, e.g., including the multi-path effects, that characterize the propagation environment. The ML model may be taught to distinguish the propagation environments of indoor and outdoor and to classify the UE presence based on that. The ML model can be taught offline and not necessarily need to be specific to given cell. The ML model can be provided as part of the algorithm e.g., as a configuration set of the algorithm. The result whether the UE is indoor or outdoor may then be used in an application or another network node performing e.g. cell planning. For example, a signalling measurement indicating a low signaling strength of a cell when the UE is outdoor may be taken into account when performing the cell planning as opposed to a similar measurement when the UE is indoor.

Note that in a general scenario the term “radio network node” can be substituted with “transmission point”. Distinction between the transmission points (TPs) may typically be based on Reference Signals (RS) or different synchronization signals transmitted. Several TPs may be logically connected to the same radio network node, but if they are geographically separated, or are pointing in different propagation directions, the TPs may be subject to the same mobility issues as different radio network nodes. In subsequent sections, the terms “radio network node” and “TP” can be thought of as interchangeable.

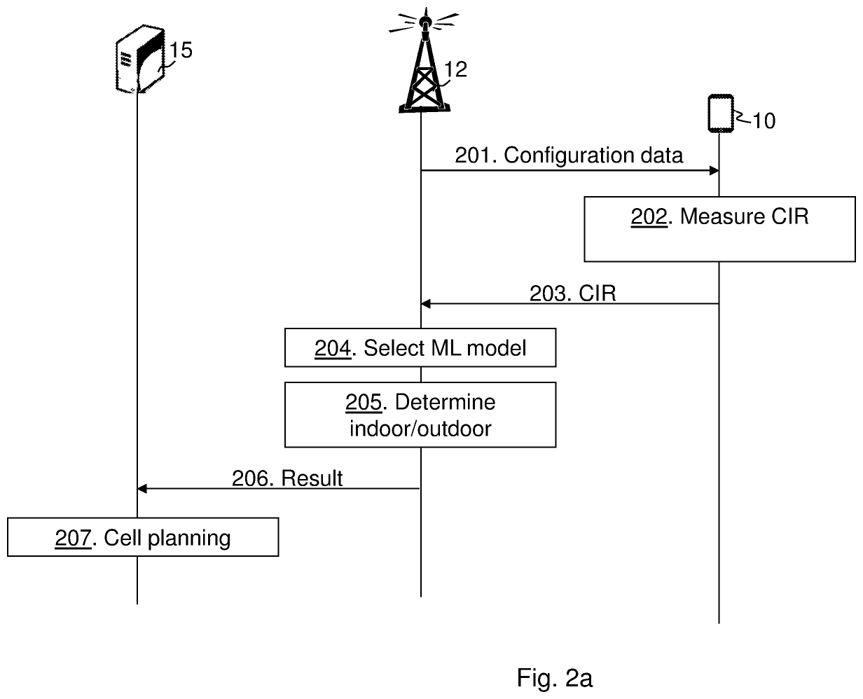

FIG. 2a is a combined flowchart and signalling scheme according to embodiments herein. The actions may be performed in any suitable order.

Action 201. The radio network node 12 may transmit configuration data to the UE 10 for measuring the CIR.

Action 202. The UE 10 may then measure the CIR on reference signals from the radio network node 12.

Action 203. The UE 10 may then report the measured CIR to the radio network node 12. Furthermore, the UE 10 may for training purposes further report whether the UE 10 is indoor or outdoor by reporting data indicating indoor position or outdoor position, also referred to as evidence data.

Action 204. The radio network node 12 may select an ML model out of a number of ML models based on characteristics of the CIR and/or positioning data.

Action 205. The radio network node 12 may then determine whether the UE 10 is indoors or outdoors using the ML model with the measurement of the CIR as input. It should further be noted that in case the UE 10 reports data indicating indoor position or outdoor position, the radio network node 12 may train an ML model using the CIR and the data.

Action 206. The radio network node 12 may then provide a result of the ML model i.e. whether the UE 10 is indoor or outdoor, to another network node and/or an application.

Action 207. The other network node or the application may use the result e.g. when performing cell planning.

FIG. 2b is a combined flowchart and signalling scheme according to embodiments herein. The actions may be performed in any suitable order.

Action 211. The radio network node 12 may transmit configuration data to the UE 10 for measuring the CIR.

Action 212. The UE 10 may then measure the CIR on reference signals from the radio network node 12.

Action 213. The UE 10 may select an ML model out of a number of ML models based on characteristics of the CIR and/or positioning data.

Action 214. The UE 10 may then determine whether the UE 10 is indoors or outdoors using the ML model with the measurement of the CIR as input.

Action 215. The UE 10 may then provide a result of the ML model i.e. whether the UE 10 is indoor or outdoor, to the radio network node 12, another network node and/or an application.

Action 216. The other network node or the application may use the result e.g. when performing cell planning.

FIG. 2c is a combined flowchart and signalling scheme according to embodiments herein. The actions may be performed in any suitable order.

Action 221. The radio network node 12 may transmit configuration data to the UE 10 for transmitting Sounding Reference Signals (SRS).

Action 222. The UE 10 may then transmit SRSs as configured by the configuration data.

Action 223. The radio network node 12 may then measure the CIR on the SRSs.

Action 224. The radio network node 12 may select an ML model out of a number of ML models based on characteristics of the CIR and/or positioning data.

Action 225. The radio network node 12 may then determine whether the UE 10 is indoors or outdoors using the ML model with the measurement of the CIR as input.

Action 226. The radio network node 12 may then provide a result of the ML model i.e. whether the UE is indoor or outdoor, to another network node and/or an application.

Action 227. The other network node or the application may use the result e.g. when performing cell planning.

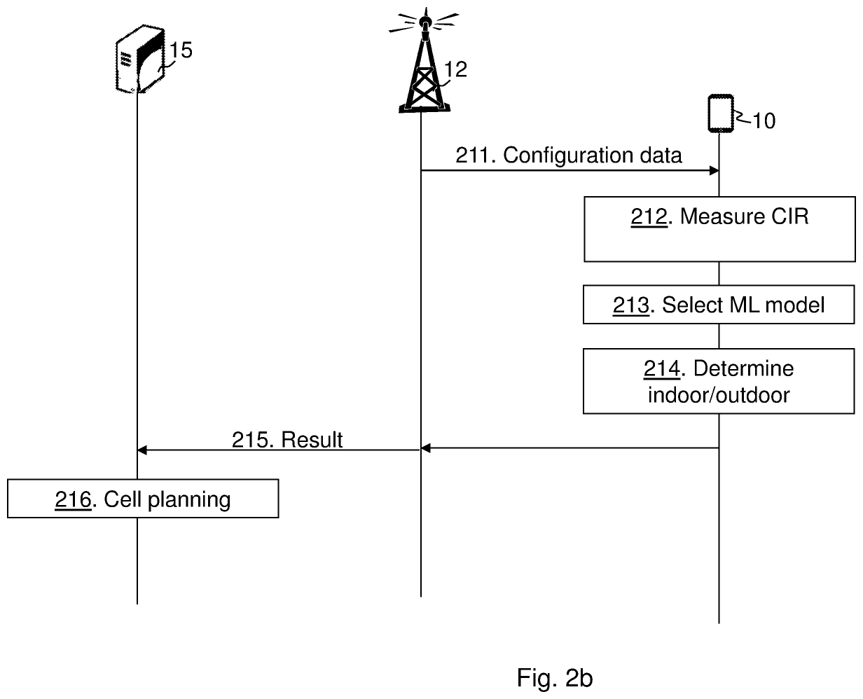

Functional blocks and their communication in different embodiments are shown in FIG. 3 with a description below.

Common to all solutions is that an Artificial Intelligence (AI) logic i.e. the ML model such as a Convolutional Neural Network (CNN) or a Deep Neural Network (DNN), determines the UE environment, i.e., whether indoor or outdoor based on the observed radio CIR. The radio CIR is already measured and used for to assist the decoding the normal data communication.

The CIR is measured by observing reference symbols transmitted by the radio network node 12 in the downlink, or in a similar way by the UE 10 in the uplink, whose waveform is known a priori. By observing the distortion imposed by the channel on the reference signal, the channel gain and phase shift, together constituting the CIR, may be obtained.

Today the UE 10 may perform measurements on the reference symbols and obtains the CIR but the UE 10 does not report it directly. In prior art, the UE reports only a condensed information, such as an average signal strength, e.g. averaged in frequency and time, or the Channel Quality Indicator (CQI), which is an indirect quality indicator of the channel to assist the modulation and coding scheme selection in the network. This means that the current measurement reporting mechanism is not sufficient to exchange the detailed channel response characteristics.

According to some embodiments herein the UE 10 performs the measurements on the reference symbols and obtains the CIR as done normally for transmission decoding. However, the UE reporting mechanism of the UE 10 is extended with a new information element that may carry the detailed CIR, see FIG. 2a, in the simplest case the CIR curve itself. This means that the channel response gain is not averaged over the frequency domain but reported for each reference symbol in the frequency space. In some embodiments, time domain averaging may be kept.

An alternative option is to run the inference of the ML model at the UE 10, see FIG. 2b, in which case only the result of the environment classification is reported to the radio network node 12. This realization puts higher computation requirements on the UE 10, but communication volume is reduced.

In case of a 20 MHz LTE carrier, there are 800 reference symbols during a 1 ms subframe, spanning through 400 carriers in the frequency space. This means that 400 distinct values may be produced per 1 ms, which may be further aggregated in time, e.g., per 10-100 ms, and then reported as 400 values. This information may be carried as a new field in an extended Radio Resource Control (RRC) measurement report.

In some embodiments, see FIG. 2c, there is no need to measure and report from the UE 10, the CIR is measured in the uplink by the radio network node 12. The benefit is that there is no impact on the UE 10 but there needs to be uplink SRSs sent from the UE which is used by the radio network node 12 to estimate the channel. However, due to resource constraints these symbols, they cannot be sent continuously, as opposed to downlink reference symbols. In this case, the radio network node 12 may expose this information so that it may be correlated with the coverage related reports of the UE 10. This may be done, e.g., in existing Operation and Maintenance (O&M) reporting frameworks, such as Cell Trace (CTR) or UE Trace (UETR), where the measurement reports are equipped with user identities.

Thus, it is herein provided a method to classify and to determine the UE propagation environment based on observed patterns in the measured CIR. The decision is made by the ML model that may be previously trained for the environment detection. The result of the ML model may be added to the radio quality measurements for radio design purposes. The training of the ML model, used to determine indoor/outdoor presence, may be done either offline and/or continuously online. In the offline case, training samples may be generated, e.g., by executing directed test drives or walks, where the presence of the measurement is explicitly known. E.g., collecting a set of measurements inside a building and outdoors around the building, label the measurements to be labelled inside or outside, and then train the ML model with the labelled data. In an online realization of the training of the ML model, the measurement data is collected and labelled, i.e., whether indoor or outdoor, online e.g. adding the evidence data to the report of the CIR. The labeling can be done automatically when an independent source of information, e.g., from location sensors or localization system, is available.

Turning back to FIG. 3, the UE side components include a capability to report detailed Channel State Information (CSI) information (see FIG. 2a) and existing standard SRS signal transmission (see FIG. 2c). The UE side reporting, actions 301a-302a, may be extended with reporting evidence data whenever available. Evidence data may be W-Fi signals or GPS position or other type of data that may be used to determine the true location of the UE. Evidence data is needed only for ML model training and we cannot assume that it is always available.

Network side components include a measurement configuration and report handling component, which includes the SRS signal reception (standard solution) see actions 301b-302b.

The radio network node 12 may handle measurements, see action 303. The reported data sample (or a measured sample) is fed into the predictor that executes a prediction to determine indoor/outdoor location of the UE, see action 304. In some embodiments the reported data sample may instead be a measured sample. The ML model is fetched from a central database, see action 307, and the model may be specific to the particular cell or region, which allows to take into account environment specific details in the ML model. The result of the prediction is stored in a database, see action 308, which can provide an Application Programming Interface (API) to other applications, e.g., Network Design Optimization (NDO) applications, to fetch data for specific UE location.

The reported sample, in case it includes evidence data, see action 305, may be used to continuously update the corresponding ML model, see action 306, and thereby ensure that the prediction model, is always adapting and improving. As more and more evidence data are collected, the indoor or outdoor prediction will thus become more and more accurate.

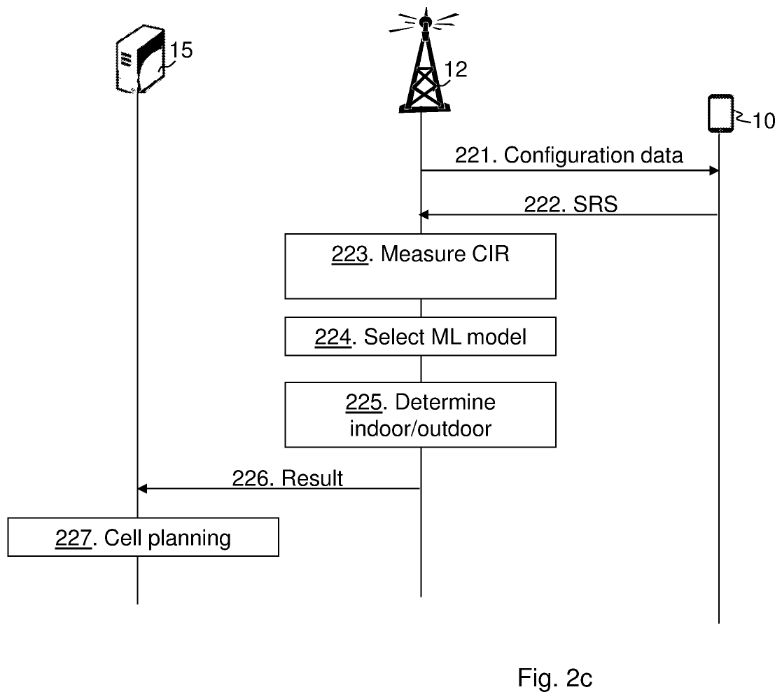

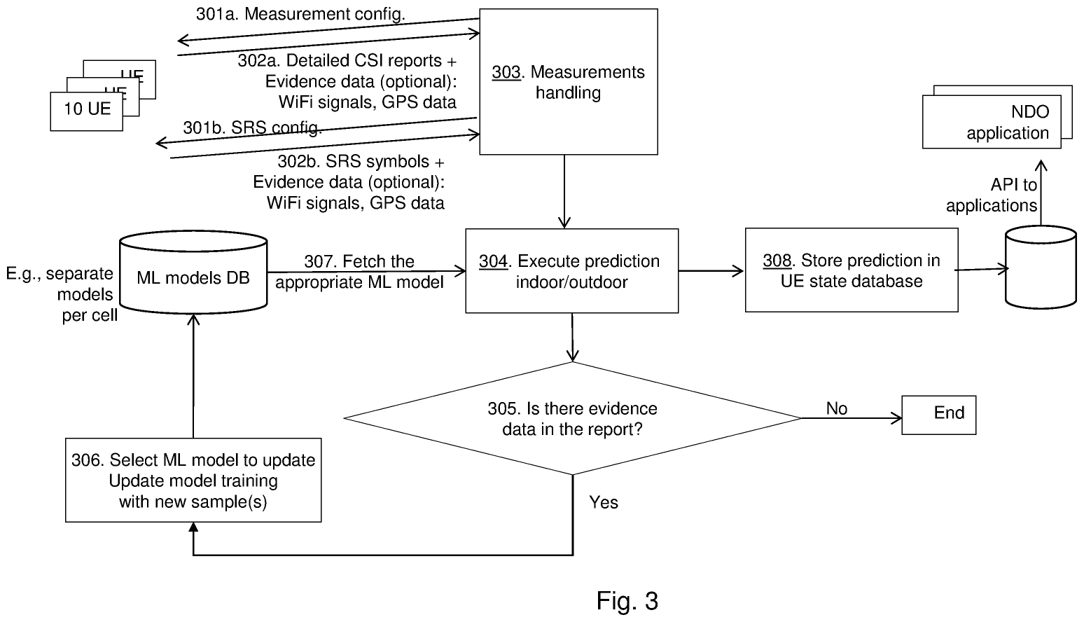

An example channel response measured in a real LTE network for an indoor cell is shown in FIG. 4. The graph shows the channel gain in terms of frequency, where the frequency band spend a 20 MHz LTE carrier. The shape of the channel response curve is primarily determined by the multi-path property of the channel, i.e., the number of different signal propagation paths and their relation in terms of shifted delay and attenuation. As a comparison we show a channel response in case of a typical outdoor cell in FIG. 5. the different pattern an outdoor cell shows, which is due to the higher number of alternative signal propagation paths, results in a much higher frequency variability of the channel gain. This difference of the channel gain patterns is learned by the ML model and used to determine whether the UE 10 is located indoor or outdoor

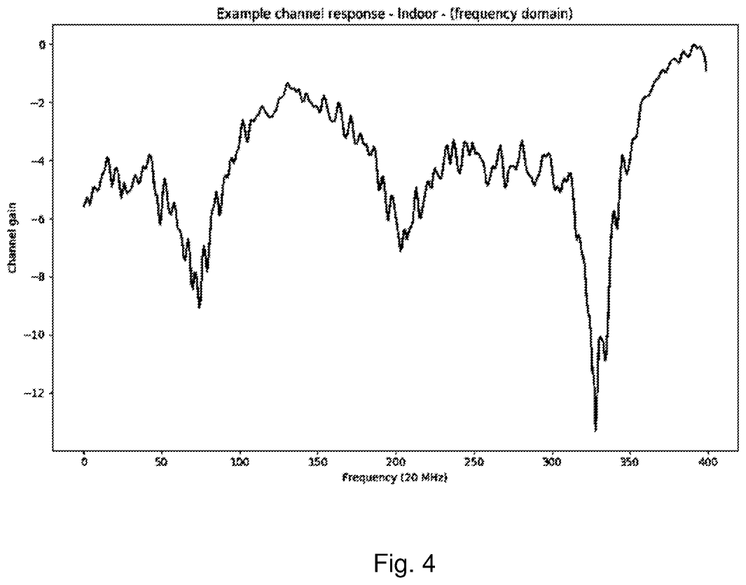

The method actions performed by the UE 10 for handling positioning, e.g. handling determination of environment presence of the UE, in the wireless communication network 1 according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The UE 10 may receive configuration for measuring the CIR.

Action 602. The UE 10 measures the CIR of a signal from the radio network node 12.

Action 603. The UE 10 initiates a process for determining whether the UE 10 is indoors or outdoors using the ML model with the measured CIR as input. For example, the UE 10 may initiate the process by reporting the measured CIR to the radio network node 12. The UE 10 may additionally include data, i.e. evidence data, indicating indoor position or outdoor position in the reporting. Alternatively, the UE 10 may initiate the process by using the ML model with the CIR as input to determine whether the UE 10 is indoors or outdoors, and then the UE 10 may transmit the result of the ML model to the radio network node 12. Thus, the CIR may be measured either on downlink reference symbols received by the UE 10 or on uplink reference symbols measured by the radio network node 12. In the former case the ML model may be placed in the UE 10, reporting the indoor/outdoor classification result only, or the ML model may be placed in the network, which requires raw data, CIR, to be sent uplink by the UE 10. The ML model may be a supervised classifier model, for example, based on a CNN to account for locality properties in the time-frequency 2D space, or even time-frequency-port 3D space. But it may, of course, be of another class of classifier ML models.

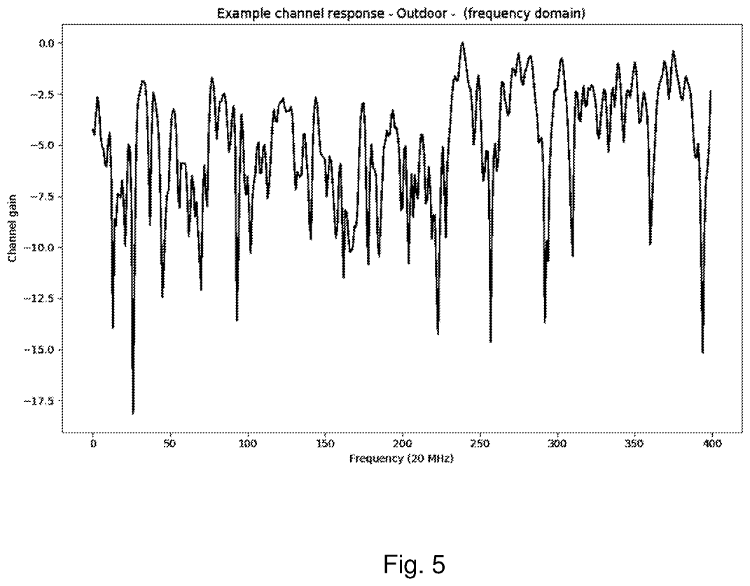

The method actions performed by the radio network node 12 for handling positioning of the UE 10, e.g. handling determination of environment presence of the UE in the wireless communication network 1 according to embodiments herein will now be described with reference to a flowchart depicted in FIG. 7. The actions do not have to be taken in the order stated below, but may be taken in any suitable order. Actions performed in some embodiments are marked with dashed boxes.

Action 701. The radio network node 12 may configure the UE 10 for measuring the CIR.

Action 702. The radio network node 12 obtains the measurement of the CIR of a signal in the wireless communication network. The radio network node 12 may obtain the measurement by receiving, from the UE 10, the report with the measurement of the CIR. Alternatively, the radio network node 12 may obtain the measurement by measuring the CIR of a signal from the UE 10 such as an SRS.

Action 703. For training the ML model, the radio network node 12 may receive the data indicating indoor position or outdoor position of the UE 10. The measurement of the CIR and the data may thus be used to train the ML model. The data may be GPS information with the CIR measurement or similar. The parameters of the ML model for training may be time-series of CIR values and the environment labels, e.g., such as indoor or outdoor.

Action 704. The radio network node 12 may select the ML model out of a number of ML models based on characteristics of the CIR and/or positioning data, e.g. the selection may be based on non-CIR auxiliary data e.g. cell id, radio parameters, frequency, etc., that are available from the network or the UE 10 during inference. In this case, ML model selection may be applied to both training and inference. If model selection was based on CIR, then in some embodiments, it may be built into the ML model itself. The ML model or the number of ML models may be differentiated, e.g., for specific cells, cell size, carrier frequencies, frequency bandwidth, number of antenna ports in UE 10 or radio network. The ML model may be a supervised classifier model, for example, based on a CNN to account for locality properties in the time-frequency 2D space, or even time-frequency-port 3D space. But it may, of course, be of another class of classifier ML models.

Action 705. The radio network node 12 determines whether the UE 10 is indoors or outdoors using the ML model with the measurement of the CIR as input. For example, the input may be the time-series of CIR values or some compressed form of the CIR values over a time series: e.g., sub-sampled or smoothed in time and/or frequency. The input may further upon selection of ML model be auxiliary data for model selection such as non-CIR auxiliary data e.g. cell id, radio parameters, frequency, etc.

Action 706. The radio network node 12 may provide the result of the used ML model to another network node and/or an application.

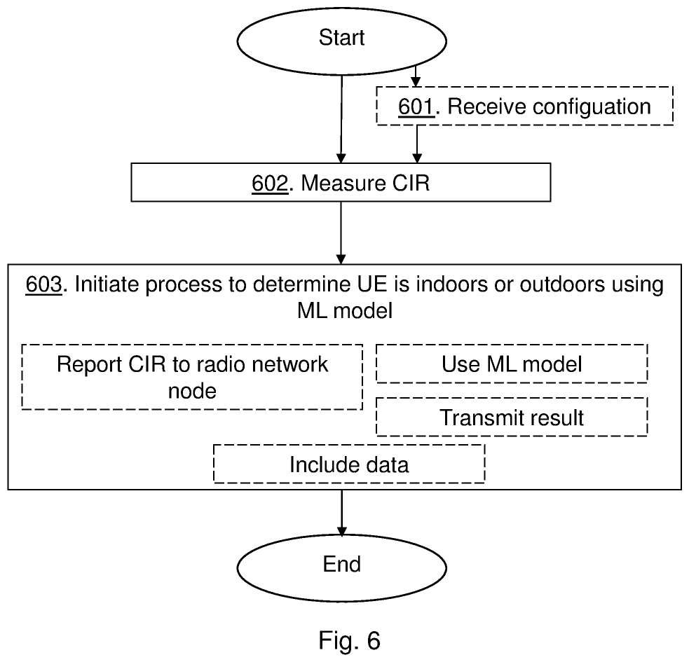

FIG. 8 is a block diagram depicting the UE 10 for handling positioning of the UE 10 in the wireless communication network 1, e.g. handling determination of environment presence of the UE, according to embodiments herein.

The UE 10 may comprise processing circuitry 801, e.g. one or more processors, configured to perform the methods herein.

The UE 10 may comprise a measuring unit 802. The UE 10, the processing circuitry 801, and/or the measuring unit 802 is configured to measure the CIR of a signal from the radio network node 12.

The UE 10 may comprise an initiating unit 803. The UE 10, the processing circuitry 801, and/or the initiating unit 803 is configured to initiate the process for determining whether the UE is indoors or outdoors using the ML model with the measured CIR as input. The UE 10, the processing circuitry 801, and/or the initiating unit 803 may be configured to initiate the process by reporting the measured CIR to the radio network node 12. Data indicating indoor position or outdoor position may be included in the reporting. The UE 10, the processing circuitry 801, and/or the initiating unit 803 may be configured to initiate the process by using the ML model with the CIR as input to determine whether the UE 10 is indoors or outdoors. The ML model may be a supervised classifier model. The UE 10, the processing circuitry 801, and/or the initiating unit 803 may be configured to initiate the process by further transmitting the result of the ML model to the radio network node 12.

The UE 10 may comprise a receiving unit 804, e.g. a receiver or a transceiver. The UE 10, the processing circuitry 801, and/or the receiving unit 804 may be configured to receive configuration for measuring the CIR.

The UE 10 further comprises a memory 805. The memory comprises one or more units to be used to store data on, such as indications, CIR measurements, measurement configurations, ML models, RSs, strengths or qualities, indications, requests, commands, timers, applications to perform the methods disclosed herein when being executed, and similar. The UE 10 comprises a communication interface comprising one or more antennas.

The methods according to the embodiments described herein for the UE 10 are respectively implemented by means of e.g. a computer program product 806 or a computer program, comprising instructions, i.e., software code portions, which, when executed on at least one processor, cause the at least one processor to carry out the actions described herein, as performed by the UE 10. The computer program product 806 may be stored on a computer-readable storage medium 807, e.g. a Universal Serial Bus (USB) stick, a disc or similar. The computer-readable storage medium 807, having stored thereon the computer program product, may comprise the instructions which, when executed on at least one processor, cause the at least one processor to carry out the actions described herein, as performed by the UE 10. In some embodiments, the computer-readable storage medium may be a non-transitory or a transitory computer-readable storage medium. Thus, embodiments herein may disclose the UE 10 for handling determination of environment presence of the UE in the wireless communications network, wherein the UE 10 comprises processing circuitry and a memory, said memory comprising instructions executable by said processing circuitry whereby said UE 10 is operative to perform any of the methods herein.

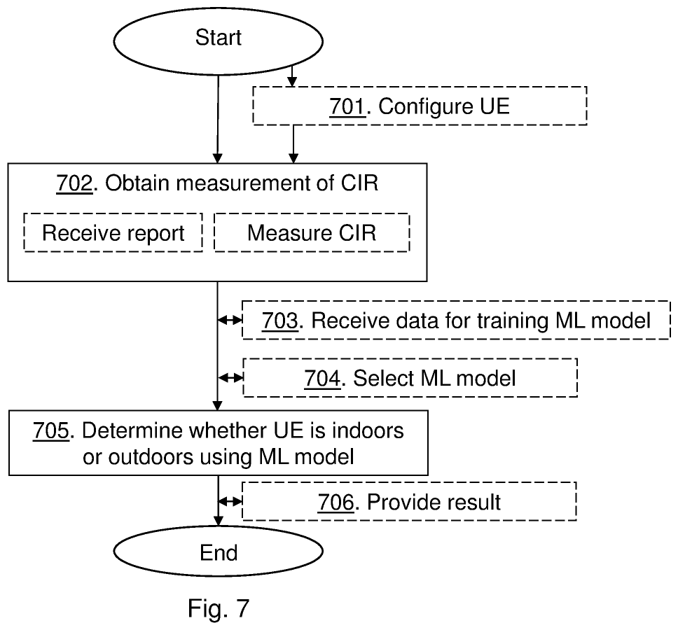

FIG. 9 is a block diagram depicting the radio network node 12 for handling positioning of the UE 10 in the wireless communication network 1, e.g. determining environment presence of the UE 10, according to embodiments herein.

The radio network node 12 may comprise processing circuitry 901, e.g. one or more processors, configured to perform the methods herein.

The radio network node 12 may comprise an obtaining unit 902, e.g. a receiver, a transceiver, or a measuring unit. The radio network node 12, the processing circuitry 901 and/or the obtaining unit 902 is configured to obtain the measurement of the CIR of the signal in the wireless communication network. The radio network node 12, the processing circuitry 901 and/or the obtaining unit 902 may be configured to obtain the measurement of the CIR by receiving, from the UE 10, the report with the measurement of the CIR. The radio network node 12, the processing circuitry 901 and/or the obtaining unit 902 may be configured to obtain the measurement of the CIR by measuring the CIR of the signal from the UE 10. The radio network node 12, the processing circuitry 901 and/or the obtaining unit 902 may be configured to receive data indicating indoor position or outdoor position of the UE 10.

The radio network node 12 may comprise a determining unit 903. The radio network node 12, the processing circuitry 901 and/or the determining unit 903 is configured to determine whether the UE 10 is indoors or outdoors using the ML model with the measurement of the CIR as input. The radio network node 12, the processing circuitry 901 and/or the determining unit 903 may be configured to train the ML model by using the measurement of the CIR and the data.

The radio network node 12 may comprise a selecting unit 904. The radio network node 12, the processing circuitry 901 and/or the selecting unit 904 may be configured to select the ML model out of a number of ML models based on characteristics of the CIR and/or positioning data.

The radio network node 12 may comprise a configuring unit 905. The radio network node 12, the processing circuitry 901 and/or the configuring unit 905 may be configured to configure the UE 10 for measuring the CIR.

The radio network node 12 may comprise a providing unit 906. The radio network node 12, the processing circuitry 901 and/or the providing unit 906 may be configured to provide the result of the used ML model to another network node and/or an application.

The radio network node 12 further comprises a memory 907. The memory comprises one or more units to be used to store data on, such as measurements, ML models, data, indications, strengths or qualities, grants, scheduling information, timers, applications to perform the methods disclosed herein when being executed, and similar. The radio network node 12 comprises a communication interface comprising transmitter, receiver, transceiver and/or one or more antennas.

The methods according to the embodiments described herein for the radio network node 12 are respectively implemented by means of e.g. a computer program product 908 or a computer program product, comprising instructions, i.e., software code portions, which, when executed on at least one processor, cause the at least one processor to carry out the actions described herein, as performed by the radio network node 12. The computer program product 908 may be stored on a computer-readable storage medium 909, e.g. a USB stick, a disc or similar. The computer-readable storage medium 909, having stored thereon the computer program product, may comprise the instructions which, when executed on at least one processor, cause the at least one processor to carry out the actions described herein, as performed by the radio network node 12. In some embodiments, the computer-readable storage medium may be a non-transitory or transitory computer-readable storage medium. Thus, embodiments herein may disclose the radio network node 12 for determining environment presence of the UE in the wireless communications network, wherein the radio network node 12 comprises processing circuitry and a memory, said memory comprising instructions executable by said processing circuitry whereby said radio network node is operative to perform any of the methods herein.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), Base Station (BS), multi-standard radio (MSR) radio node such as MSR BS, eNodeB, network controller, RNC, BSC, relay, donor node controlling relay, base transceiver station (BTS), AP, transmission points, transmission nodes, Remote Radio Unit (RRU), Remote Radio Head (RRH), nodes in distributed antenna system (DAS), CN node e.g. Mobility Switching Centre (MSC), Mobile Management Entity (MME) etc., O&M, Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or UE is used and it refers to any type of wireless device communicating with a network node and/or with another UE in a cellular or mobile communication system. Examples of UE are target device, D2D UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions, means or modules may be implemented using digital logic and/or one or more microcontrollers, microprocessors, or other digital hardware. In some embodiments, several or all of the various functions may be implemented together, such as in a single Application-Specific Integrated Circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, Digital Signal Processor (DSP) hardware, Read-Only Memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

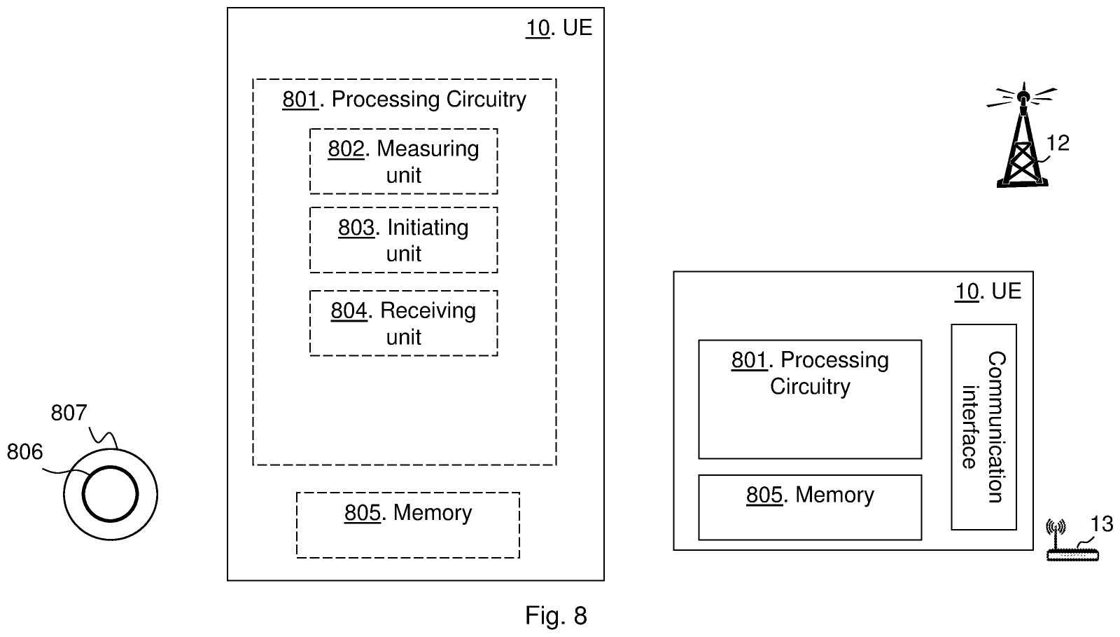

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first UE 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

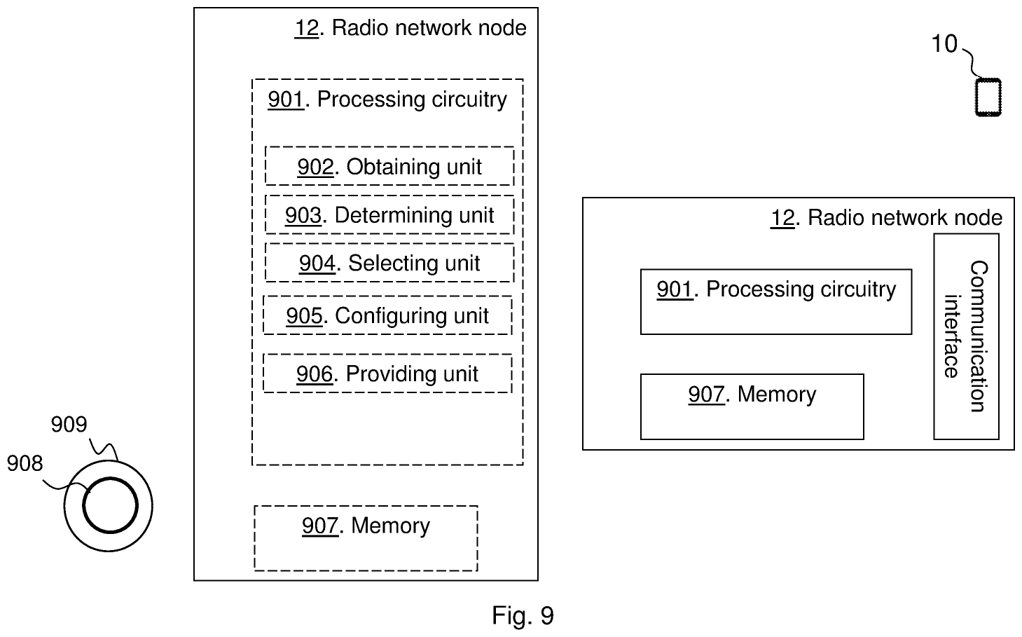

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the coverage of UEs indoors as well as outdoors when performing the cell planning and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

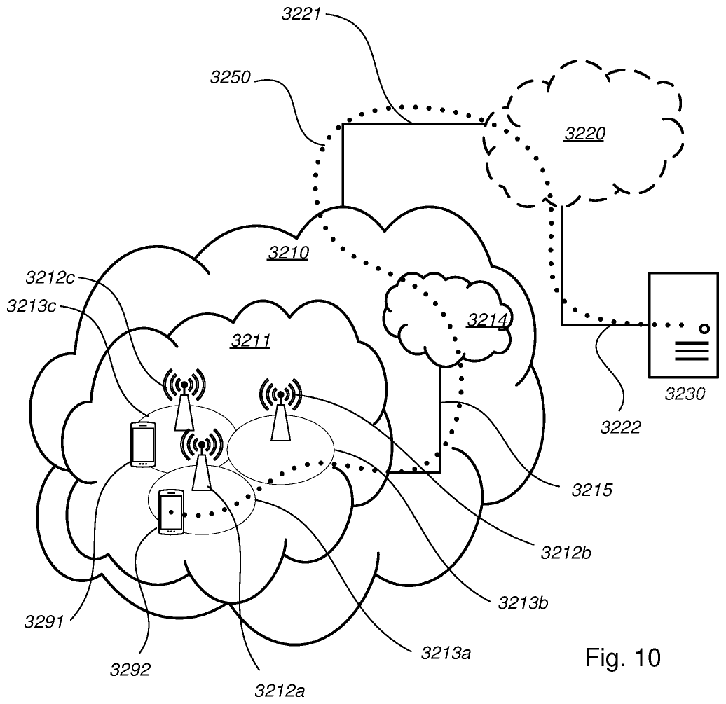

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

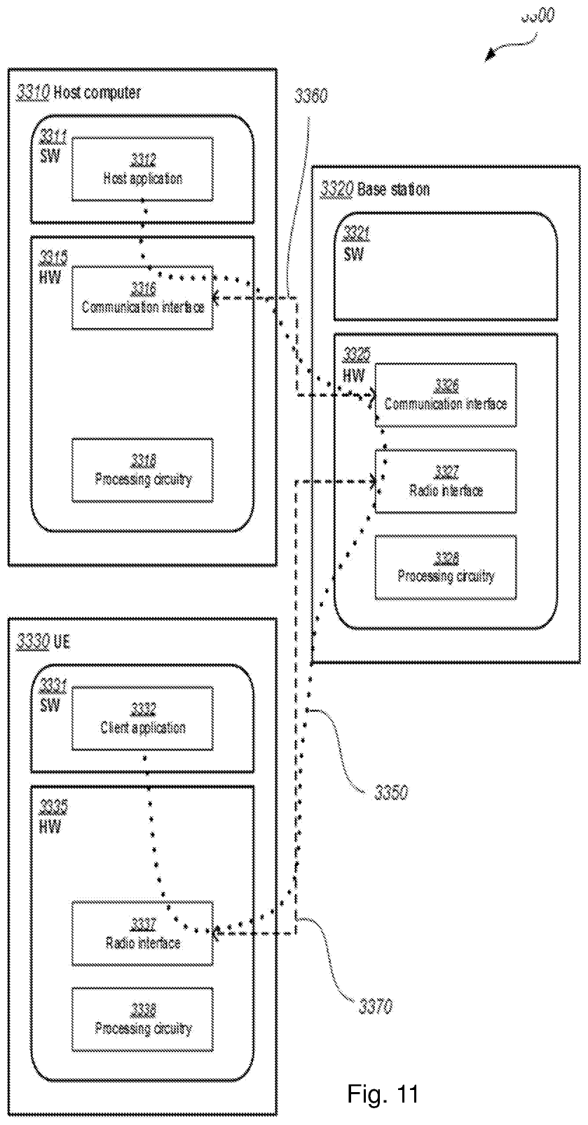

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

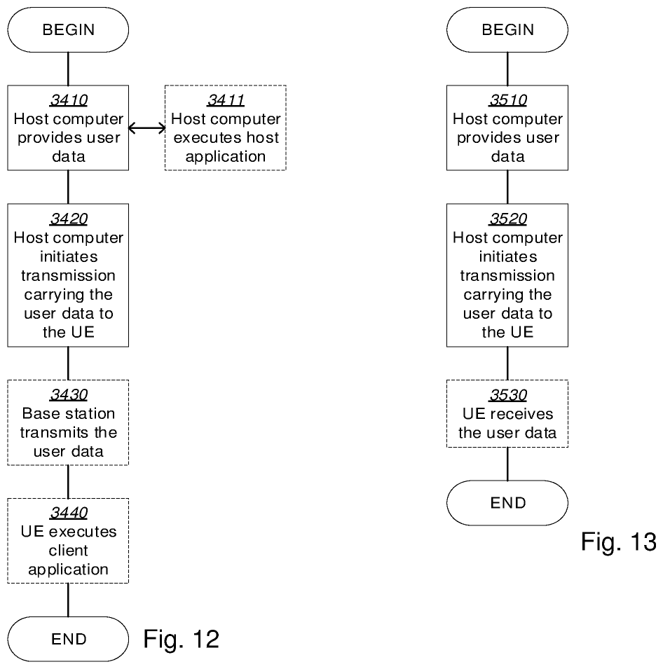

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

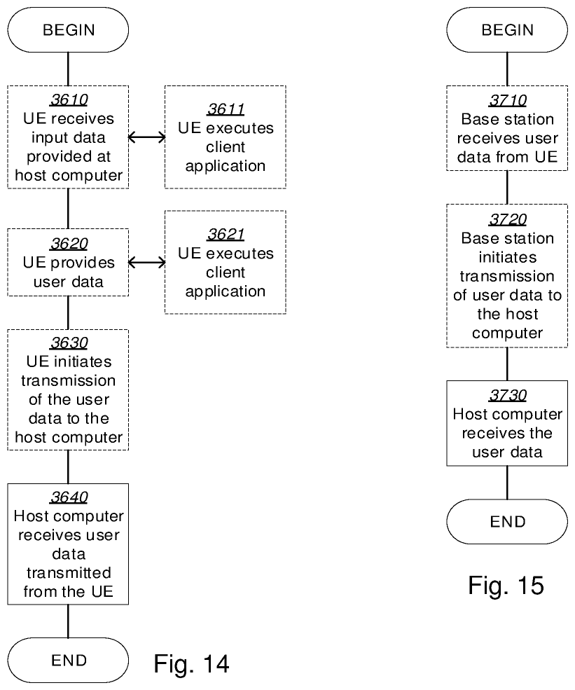

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### ABBREVIATIONS

AI Artificial Intelligence
CSI Channel Signal Indicator
CQI channel Quality Indicator
GPS Global Positioning System
MHz Mega Hertz
ML Machine Learning
NDO Network Design Optimization
SRS Surrounding Reference Signal
UE User Equipment

1. A method performed by a user equipment, UE, for handling positioning of the UE in a wireless communication network, the method comprising:
measuring a channel impulse response, CIR, of a signal from a radio network node; and
initiating a process for determining whether the UE is indoors or outdoors using a machine learning, ML, model with the measured CIR as input.

2. The method according to claim 1, wherein initiating the process comprises reporting the measured CIR to the radio network node.

3. The method according to claim 2, wherein data indicating indoor position or outdoor position is included in the reporting.

4. The method according to claim 1, wherein initiating the process comprises using the ML model with the CIR as input to determine whether the UE is indoors or outdoors.

5. The method according to claim 4, wherein initiating the process further comprises transmitting a result of the ML model to the radio network node.

6. The method according to claim 1, further comprising receiving a configuration for measuring the CIR.

7. The method according to claim 1, wherein the ML model comprises a supervised classifier model.

8. A method performed by a radio network node for handling positioning of a user equipment, UE, in a wireless communication network, the method comprising:
obtaining a measurement of a channel impulse response, CIR, of a signal in the wireless communication network; and
determining whether the UE is indoors or outdoors using a machine learning, ML, model with the measurement of the CIR as input.

9. The method according to claim 8, wherein obtaining the measurement of the OR comprises receiving, from the UE, a report with the measurement of the CIR.

10. The method according to claim 8, wherein obtaining the measurement of the OR comprises measuring the CIR of a signal from the UE.

11. The method according to claim 8, further comprising receiving data indicating indoor position or outdoor position of the UE.

12. The method according to claim 11, wherein the measurement of the CIR and the data is used to train the ML model.

13. The method according to claim 8, further comprising selecting the ML model out of a number of ML models based on characteristics of the CIR and/or positioning data.

14. The method according to claim 8, further comprising configuring the UE for measuring the CIR.

15. The method according to claim 8, further comprising providing a result of the used ML model to another network node and/or an application.

16. The method according to claim 8, wherein the ML model comprises a supervised classifier model.

17. (canceled)

18. (canceled)

19. A user equipment, UE, for handling positioning of the UE in a wireless communication network, wherein the UE is configured to:
measure a channel impulse response, CIR, of a signal from a radio network node; and
initiate a process for determining whether the UE is indoors or outdoors using a machine learning, ML, model with the measured CIR as input.

20. The UE according to claim 19, wherein the UE is configured to initiate the process by reporting the measured CIR to the radio network node.

21. The UE according to claim 20, wherein data indicating indoor position or outdoor position is included in the reporting.

22. The UE according to claim 19, wherein the UE is configured to initiate the process by using the ML model with the CIR as input to determine whether the UE is indoors or outdoors.

23.-32. (canceled)
